(19) United States
(12) Patent Application Publication
(10) Pub. No.: US 2014/0250881 A1
(43) Pub. Date: Sep. 11, 2014

(54) ACTUATOR

(71) Applicants: Jun Yamamoto, Tokyo (JP); Sotomitsu Ikeda, Yokohama-shi (JP)

(72) Inventors: Jun Yamamoto, Tokyo (JP); Sotomitsu Ikeda, Yokohama-shi (JP)

(73) Assignee: CANON KABUSHIKI KAISHA, Tokyo (JP)

(21) Appl. No.: 14/237,342

(22) PCT Filed: Jul. 25, 2012
(86) PCT No.: PCT/JP2012/069922

§ 371 Date: Feb. 5, 2014

(30) Foreign Application Priority Data
Aug. 9, 2011 (JP) 2011-173941

(51) Int. Cl. F03G 7/00

(52) U.S. Cl. CPC F03G 7/00
USPC 60/527

(57) ABSTRACT

This invention provides an actuator which is easy to control the drive and has large generative force.

The actuator is an actuator having a cylindrical outer frame body which expands in the side surface direction to bring the bottom portion and the top portion close to each other and a deformation unit which is accommodated in the outer frame body and has a plurality of deformation elements which are deformed by applying a voltage, in which, in the deformation unit, the plurality of deformation elements are mutually deformed when a voltage is applied to press and expand the outer frame body in the side surface direction.

### TECHNICAL FIELD

The present invention relates to an actuator.

### BACKGROUND ART

An ion migration polymer actuator causes electrochemical expansion and contraction action with the migration of ions into an electrode layer. The application of such a polymer actuator to substances increased in size from small substances, such as artificial muscles, robot arms, artificial arms, and micromachines, has drawn attention.

As actuators employing a polymer actuator, PTL 1 discloses an integrated structure in which a plurality of long actuators exhibiting bending action caused by energization are combined. These actuators have a structure in which units containing long actuators are laminated and which has a long shape in the lamination direction as a whole and transmits displacement and force generated by the bending action of the long actuators in the lamination direction.

In order to increase the generative force of the actuators of the integrated structure, it is important to increase the generative force of the long actuators as a constituent element and increase the area on which the long actuators exert the force. However, the structure of PTL 1 has posed a problem in that the region on which the force is exerted is only the cross section perpendicular to the lamination direction of the actuator, so that sufficient force is not obtained.

In contrast, PTL 2 describes an expansion and contraction drive type actuator containing a cylindrical outer shell structure in which rigid fiber materials are woven in the shape of a sheath and a tube body which is disposed in the structure and is elastically deformed. The tube body is provided with an air inlet. By expanding the tube body by air pressure, the tube body presses and expands the outer shell structure. Due to the fact that the outer shell structure is pressed and expanded in the diameter direction of the cylinder, the outer shell contracts in such a manner as to change the woven angle of the fiber material and simultaneously reduce the height of the cylinder. Thus, an air pressure actuator has a mechanism which converts the isotropic pressure exerted by the internal air to force in a fixed direction. Due to that fact that the force with which the internal air presses the side surface of the cylinder can be added and utilized, sufficient force can be obtained, so that the force of the actuator can be increased.

However, the actuator described in PTL 2 requires a pump unit for introducing air to the inside thereof and a tube body having a thickness for holding air pressure, and thus it has been difficult to reduce the size thereof. Moreover, it has been difficult to finely control displacement caused by the expansion and contraction movement by air pressure and to control the tube shape after expansion, so that the actuator often has problems in using the same upon being installed in an apparatus as one device having a specific function.

### CITATION LIST

### Patent Literature

PTL 1 Japanese Patent Laid-Open No. 2007-118159
PTL 2 Japanese Patent Laid-Open No. 2010-127429

### Non Patent Literature

NPL 1 “Pneumatic artificial muscles: Actuators for robotics and automation” written by Frank Daerden, Dirk Lefeber, et al.
NPL 2 “Sensors and Actuators A 132 (2006) 616-625” written by Gursel Alici, Nam N. Huynh, et al.

### SUMMARY OF INVENTION

The present invention provides an actuator in which the drive control is easy and the generative force is large.

The actuator according to the invention is an actuator having a cylindrical outer frame body which expands in the side surface direction to bring the bottom portion and the top portion close to each other and a deformation unit which is accommodated in the outer frame body and has a plurality of deformation elements which are deformed by applying a voltage, in which, in the deformation unit, the plurality of deformation elements are mutually deformed when a voltage is applied to press and expand the outer frame body in the side surface direction.

According to the invention, when a drive voltage is applied, the plurality of deformation elements are deformed and cause the movement of expanding the outer frame body in the side surface direction. The expansion in the side surface direction is converted to the force with which the outer frame body brings the bottom portion and the top portion close to each other, i.e., contraction force. Thus, the force generated when the deformation unit is deformed can be efficiently converted to expansion and contraction force.

Furthermore, since the deformation unit can be driven by applying a voltage, the drive control becomes easy. More specifically, an actuator in which the drive control is easy and has large generative force can be provided.

### BRIEF DESCRIPTION OF DRAWINGS

FIGS. 1A to 1C are views schematically illustrating an actuator of the invention, in which FIG. 1A is a view schematically illustrating the entire structure thereof and illustrating the state before action, FIG. 1B is a cross sectional view along the IB-IB line of FIG. 1A, and FIG. 1C is a view illustrating the state after action.

FIGS. 2A to 2D are views illustrating an exemplary structure of an outer frame body of the invention.

FIGS. 3A to 3C are views illustrating an exemplary structure of a deformation element of the invention.

FIGS. 4A to 4E are views illustrating an exemplary structure when using an element which performs bending action for the deformation element of the invention.

FIGS. 5A to 5F are views illustrating another aspect of the deformation element of the invention.

FIGS. 6A to 6E are views illustrating an exemplary structure when using one which expands and contracts as a bulk for the deformation element.

FIGS. 7A and 7B are views schematically illustrating an actuator of a fourth embodiment, in which FIG. 7A is an outline view and FIG. 7B is a cross sectional view along the VIIB-VIIB line of FIG. 7A.

FIGS. 8A and 8B are views for describing the structure of the action of an ion migration type polymer actuator which is a bending element, in which FIG. 8A is a view illustrating the state before applying a voltage and FIG. 8B is a view illustrating the state after applying a voltage.

FIG. 9 is a characteristic chart illustrating the internal pressure of the actuator of the fourth embodiment.

FIG. 10 is a characteristic chart illustrating the structural calculation of the ion migration type actuator of the fourth embodiment.

FIG. 11A is an outline view illustrating a comparative aspect 1 and FIG. 11B is an outline view illustrating a comparative aspect 2.

FIGS. 12A and 12B are views illustrating an exemplary structure of an interlayer transmission member of a fifth embodiment.

FIGS. 13A and 13B are views illustrating an exemplary structure of the terminal structure and a deformation unit of a sixth embodiment.

FIGS. 14A and 14B are views illustrating an exemplary structure of electrical connection of a seventh embodiment.

### DESCRIPTION OF EMBODIMENTS

Embodiments of the invention are described in detail with reference to the drawings.

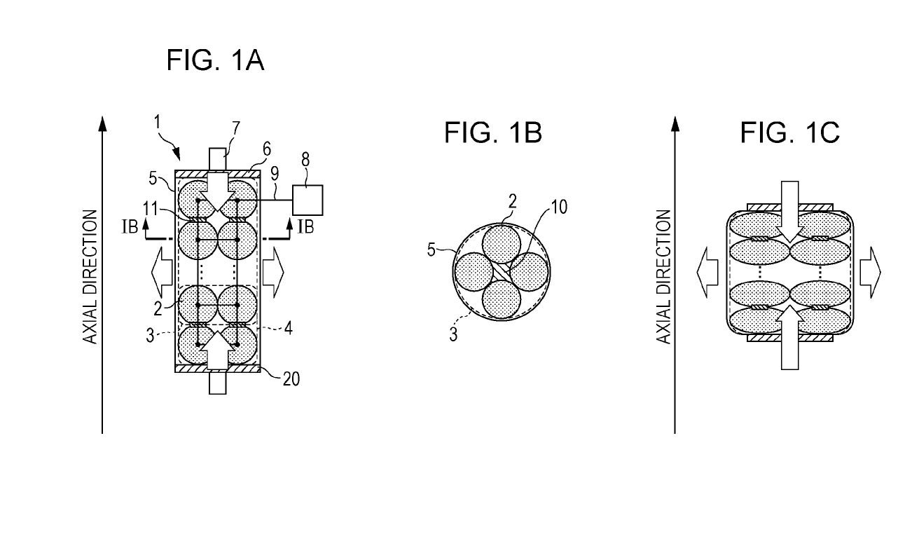

The actuator of the invention is an expansion and contraction type actuator having a cylindrical outer frame body 5 and deformation units 3 accommodated in the outer frame body as illustrated in FIGS. 1A to 1C.

FIGS. 1A to 1C are views schematically illustrating the entire structure, in which FIG. 1A is a view illustrating the state before action. FIG. 1B is a cross sectional view along the IB-IB line of FIG. 1A and FIG. 1C is a view schematically illustrating the state after the action of FIG. 1A.

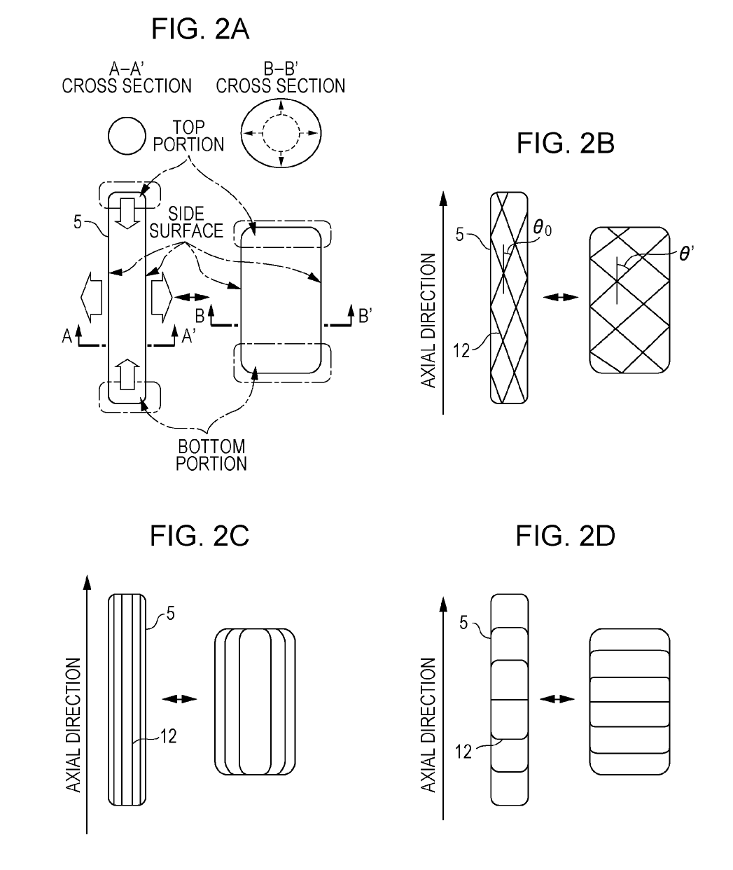

FIGS. 2A to 2D are views schematically illustrating a modification of the cylindrical outer frame body 5 of the invention. Although the details of the modification are described later, the action of the outer frame body is described based on the configuration of FIG. 2A.

As illustrated in FIGS. 2A to 2D, the cylindrical outer frame body 5 has a hollow cylindrical structure having a side surface, a top portion, and a bottom portion. As illustrated in the upper portion of FIG. 2A, the A-A′ cross section of the outer frame body 5 is suitably a circular shape but may be a polygonal shape insofar as the cylindrical shape is an endless tubular shape.

The cylindrical outer frame body 5 is configured so that the force with which the cylindrical outer frame body 5 contracts in the direction indicated by the white arrow due to the expansion in the side surface direction (the direction indicated by the black arrow of FIG. 2A), and, as a result, the bottom portion and the top portion are brought close to each other.

The deformation unit 3 accommodated in the outer frame body 5 has a plurality of deformation elements which are deformed by applying a voltage and is configured so that when a voltage is applied to the deformation unit 3, the plurality of deformation elements are mutually deformed to move in such a manner as to press and expand the outer frame body in the side surface direction as illustrated in FIG. 1C.

The cylindrical outer frame body 5 may be disposed at the periphery in such a manner as to cover the outer side of the plurality of deformation elements along the axial direction along which the outer frame body 5 expands and contracts and may be provided with output members 6 and 20 at the top portion and the bottom portion, respectively, as illustrated in FIG. 1A. Due to the fact that the output members 6 and 20 are connected, the expansion and contraction action of the outer frame body can be output as force to the outside.

Moreover, a terminal 9 for supplying a drive voltage to the plurality of deformation elements and a power supply for applying a voltage to the terminal may be provided to constitute an actuator apparatus.

The cylindrical outer frame body 5 is a structure which contracts in the above-described axial direction corresponding to extension (expansion) of the plane (e.g., IB-IB cross section of FIG. 1A) perpendicular to the axis along which the outer frame body 5 expands and contracts. A sleeve (sheath) or the like for use in a McKibben type actuator can be used.

In the actuator of the invention, when a voltage is applied to the deformation unit containing the plurality of deformation elements, the plurality of deformation elements are mutually deformed to be separated from each other in the side surface direction of the outer frame body. Thus, the movement occurs in which the deformation unit expands as a whole in the side surface direction as illustrated in the B-B′ cross section of FIG. 2A. The expansion in the side surface direction is converted to the force with which the cylindrical outer frame body brings the bottom portion and the top portion close to each other, i.e., the contraction force. Thus, the force generated when the deformation unit is deformed can be efficiently converted to the expansion and contraction force.

More specifically, the cylindrical outer frame body 5 contracts in a direction of bringing the top portion and the bottom portion close to each other (axial direction of expansion and contraction) by applying a voltage, so that the force generated by the expansion and contraction movement of the actuator can be extracted from the output members connected thereto.

As the configuration of the deformation unit in the case of using the cylindrical outer frame body illustrated in FIGS. 1A to 1C, a configuration is suitable in which deformation elements are disposed in a continuous manner from the central axis of the actuator to the side surface of the outer frame body.

Hereinafter, embodiments of the invention are described in detail with reference to the drawings.

### First Embodiment

FIGS. 1A to 1C are views schematically illustrating one embodiment of the actuator of the invention, in which FIG. 1A is a view schematically illustrating the entire structure thereof and illustrating the state before action, FIG. 1B is a cross sectional view along the IB-IB line of FIG. 1A, and FIG. 1C is a view schematically illustrating the state after the action of FIG. 1A.

An actuator 1 of this embodiment expands and contracts in one axial direction and outputs the expansion and contraction movement in the direction to the outside. The actuator 1 has a plurality of deformation units 3 continuously disposed in the axial direction, an outer frame body 5 covering the outer side of the plurality of deformation units along the axial direction, a terminal 9 for supplying a drive voltage to the plurality of deformation units, and output members 6 and 20 which are connected to the outer frame body and output the expansion and contraction movement.

The outer frame body 5 is structured in such a manner as to contract in the axial direction corresponding to the expansion of the plane perpendicular to the axis. The deformation unit contains an assembly of a plurality of deformation elements 2 which are displaced in the direction perpendicular to the axis when a voltage is applied.

In the configuration described above, the actuator outputs the displacement and the force obtained when the outer frame body contracts in the axial direction. Therefore, the axial direction of the outer frame body of the above-described configuration means the axial direction (the direction indicated by the arrow of FIGS. 1A and 1C) in which the actuator expands and contracts and the direction perpendicular to the axis of the outer frame body means the diameter direction perpendicular to the axial direction of the actuator.

Hereinafter, for convenience, the direction of extracting the displacement and the force as an actuator is referred to as an axial direction, the direction perpendicular to the direction is referred to as a diameter direction, the cross section perpendicular to the axial direction in the bottom portion of the cylindrical outer frame body is referred to as a bottom surface, a surface of the circumferential surface surrounded by the outer frame body is referred to as an inner side surface, and the peripheral side of the outer frame body is referred to as an outer side surface.

The actuator 1 of the invention has the cylindrical outer frame body 5, the terminal 9 for applying a voltage to the plurality of deformation units 3, and a power supply controller 8 connected to the terminal as illustrated in FIG. 1A.

The deformation unit 3 is configured as a unit which contains an assembly of the plurality of deformation elements 2 and moves in such a manner that the center portions of the deformation elements 2 are separated from each other. Furthermore, the deformation units 3 are constituted as a deformation unit group 4 in which the deformation units 3 are continuously disposed in the axial direction, and the deformation unit groups 4 are all accommodated in the outer frame body 5. Due to the fact that the deformation unit groups 4 are deformed in response to the control from the power supply controller 8 to press the side surface of the outer frame body 5, the outer frame body 5 expands in the diameter direction, whereby the outer frame body 5 contracts in the axial direction.

More specifically, the cylindrical outer frame body is constituted as a structure which acts with the deformation action of the deformation units based on the same principle as that of a sleeve of a so-called Mckibben type actuator.

As illustrated in FIGS. 1A to 1C, in this embodiment, the deformation unit 3, in which a plurality of deformation elements 2 are combined, is constituted and, by the application of a voltage to each of the deformation elements 2 of the deformation unit, the deformation elements are displaced in different directions perpendicular to the axis. More specifically, the plurality of deformation elements 2 constitute the deformation units 3 which move in such a manner that center portions thereof are separated from each other.

The deformation unit group 4 is one in which a plurality of the deformation units 3 are continuously disposed in such a manner as to be laminated in the axial direction from the bottom portion to the top portion. The deformation unit group 4 has a structure such that the deformation unit group 4 is covered with the outer frame body 5 as illustrated in FIG. 1A. The outer frame body 5 has a function of contracting in the axial direction when expanding in the diameter direction.

The output members 6 and 20 are disposed at the end portion of each of the top portion and the bottom portion of the actuator 1, respectively, and are connected to the outer frame body 5. At the central portion of the surface of each of the output members 6 and 20, a shaft portion 7 is provided. The actuator 1 and an external object are connected to each other with the shaft portions 7 to transmit displacement and force.

In the above-described configuration, due to the fact that the deformation unit group 4 presses and expands the outer frame body 5 in the diameter direction from the inside, the outer frame body 5 moves in such a manner as to expand in the diameter direction and simultaneously contract in the axial direction. Thus, by converting the force and the displacement in the diameter direction of the deformation unit group 4 by the outer frame body 5, the actuator 1 generates force and displacement in the axial direction.

The deformation element 2 exhibits a change of shape by the control by the power supply controller 8 and exhibits expansion/contraction or displacement in at least one direction as the entire deformation element 2. When a deformation element which isotropically expands is used, the outer frame body 5 is pressed in the axial direction from the inside, which constitutes a factor of hindering the contraction action in the axial direction of the actuator 1. Therefore, it is suitable for the deformation element 2 to exhibit displacement of expanding in at least one direction of the diameter directions and not to exhibit displacement of expanding in the axial direction. It is more suitable for the deformation element 2 to exhibit displacement of expanding in at least one direction of the diameter directions and to exhibit displacement of contracting in the axial direction.

Such action of the deformation element 2 is achieved by the adjustment by the power supply controller 8 and is achieved by a structural device of unitization of the deformation elements or the like.

The deformation element 2 exhibits deformation in response to electrical energization (voltage application). The deformation element may be an element which exhibits deformation by migration of ions, chemical changes, electrostriction, or heating as a result of energization.

For the unitization of the deformation elements 2, it is possible to employ a configuration, such as the formation of the deformation unit 3 through an intervention portion 10 as illustrated in FIG. 1B or the formation of the deformation unit group 4 by lamination of the deformation units 3 through a bonding portion 11 as illustrated in FIG. 1A.

With the configuration of this embodiment, a region on which the deformation unit group 4 exerts force is on the inner side surface of the outer frame body 5, and the force applied to the inner side surface is collected to the force of bringing the top portion and the bottom portion close to each other. In the actuator 1 having a tubular and long structure, the area of the side surface of the outer frame body 5 is much larger than the area of the bottom portion. The utilization of the side surface having an overwhelmingly larger area than the area of the bottom portion allows a further reduction in the force required per area of the deformation unit. Moreover, the pressurization by air of a former air pressure actuator is isotropic, and force is applied also to the side surface and the bottom portion. More specifically, the actuator contracts in the axial direction as a whole to generate the force, but, inside the actuator, there is a portion to which the force is applied in such a manner as to expand in the axial direction. Therefore, the internal force and the force extracted to the outside are offset each other, so that an inefficient portion has been included. In contrast, according to the configuration of the invention, the surface on which the internal bulk exerts force is only the side surface, and the offset relationship observed in an air pressure actuator is not included, so that more efficient conversion of force and displacement can be achieved.

The size of the actuator 1 of this aspect can be suitably selected according to the intended use. For example, an actuator having a cross section with a diameter of 1 mm to several tens of cm and a size in the axial direction of 1 mm to several tens of cm can be produced.

The size of the deformation element 2 disposed inside can be suitably selected according to the size of the expansion and contraction actuator 1. Similarly, the size of the deformation unit 3 and the deformation unit group 4 can also be suitably selected according to the size of the expansion and contraction actuator 1.

### Second Embodiment

In the actuator 1 of the embodiment described above, the shape of the cylindrical outer frame body 5 can be formed as in this embodiment.

FIGS. 2A to 2D are schematic views illustrating the structure of the outer frame body 5 usable in this embodiment.

The outer frame body 5 for use in this aspect may contain any material and have any structure insofar as the outer frame body has a function of contracting in the axial direction with the expansion in the diameter direction as illustrated in FIG. 2A.

Mentioned as a suitable structure is a structure such that the outer frame body 5 contains a fiber material 12 as illustrated in FIGS. 2B to 2D.

The fiber materials 12 may be woven as illustrated in FIG. 2B, may not be woven and oriented in the axial direction as illustrated in FIG. 2C, or may not be woven and disposed in the direction perpendicular to the axial direction as illustrated in FIG. 2D. It may be considered that, in FIGS. 2B and 2C, the fiber materials 12 are formed over the outer frame body 5 to both the ends of the outer frame body 5 and, in FIG. 2D, the fiber materials 12 have a composite structure with a rubber-like elastic member described later.

The woven angle θ₀ defined to the axial direction illustrated in FIG. 2B may be arbitrarily changed insofar as the effects of the invention are expected. When the woven angle is 90°, it can also be considered that the structure of FIG. 2C and the structure of FIG. 2D are combined.

The fiber materials 12 may be woven in such a manner as to be crossed or may be joined without crossing to form a mesh.

The outer frame body 5 may contain only the fiber material 12 or may have a structure in which the fiber material 12 is compounded in a rubber-like elastic member. Or, a structure may be acceptable such that the fiber materials 12 are not compounded in a rubber-like elastic member and the fiber materials 12 contact the surface of the rubber-like elastic member. Also in the formation of the composite with the elastic member, the presence of weaving or the woven angle of the fiber materials 12 inside thereof may be suitably selected as illustrated in FIGS. 2B and 2C.

The shape of the fiber material 12 may be suitably selected, e.g., a fiber shaped one as a single material, a band shaped one as a single material, one obtained by bundling fibers as a single material, or one obtained by twisting fibers as a single material, insofar as the action function of the outer frame body 5 is satisfied.

The fiber material 12 suppresses excessive expansion in the axial direction from the initial state of the outer frame body 5. The fiber material 12 is suitably a rigid material having flexibility but not having elasticity in itself. However, insofar as the function as the outer frame body 5 is satisfied, the fiber material 12 may have some elasticity.

As illustrated in FIG. 2B, when the fiber material 12 is woven, the fiber material 12 follows the change in the diameter direction of the outer frame body 5 by bending of the fibers themselves, expansion of the fibers themselves, or changing the woven angle. In FIG. 2B, an arbitrary number of the fiber materials 12 are wound with an arbitrary number of turns over the outer frame body 5 to both the ends thereof. In the initial state, the woven angle to the axial direction of the fiber materials 12 is θ₀. When the outer frame body 5 is pressed and expanded in the diameter direction from the inside, the woven angle changes to θ′ in such a manner as to follow the change in the shape and simultaneously the outer frame body 5 contracts in the axial direction.

When the fiber materials 12 are not woven and are oriented in the axial direction as illustrated in FIG. 2C, the fiber materials 12 follow the change in the diameter direction of the outer frame body 5 by bending of the fiber materials 12 or expansion of the fibers themselves. The action of the fiber materials 12 allows the outer frame body 5 to expand in the diameter direction and simultaneously contract in the axial direction.

When the fiber materials 12 are not woven and disposed in the direction perpendicular to the axial direction as illustrated in FIG. 2D, the fiber materials 12 follow the change in the diameter direction of the outer frame body 5 by bending and mainly expansion of the fiber materials 12 and follow the contraction in the axial direction of the outer frame body 5 by reducing the distance of the fiber materials 12. The action of the fiber materials 12 allows the outer frame body 5 to expand in the diameter direction and simultaneously contracts in the axial direction.

Mentioned as such a fiber material 12 are resin materials, such as general-purpose plastics, such as nylon, polyethylene, polypropylene, polyvinyl chloride, polystyrene, polyvinyl acetate, Teflon (registered trademark), ABS resin, AS resin, and acrylic resin, engineering plastics, such as polyamide, polyacetal, polycarbonate, polybutylene terephthalate, polyethylene terephthalate, and ethylene tetrafluoride, and super engineering plastics, such as polyphenylenesulfide, polytetrafluoroethylene, polysulfone, polyethersulfone, polyetheretherketone, and polyamideimide. Moreover, various ceramic materials, such as glass, alumina, zirconia, ferrite, forsterite, zircon, steatite, aluminum nitride, silicon nitride, and silicon carbide are mentioned. Moreover, various metal materials, such as gold, platinum, palladium, ruthenium, silver, iron, cobalt, nickel, copper, titanium, aluminum, magnesium, and tungsten and alloy materials containing these metals are mentioned.

When the fiber material 12 is compounded in an elastic member, mentioned as the elastic member are various rubber materials, such as natural rubber, isoprene rubber, butadiene rubber, styrene-butadiene rubber, butyl rubber, nitrile rubber, ethylene-propylene rubber, chloroprene rubber, acrylic rubber, chlorosulfonated polyethylene rubber, urethane rubber, silicone rubber, fluororubber, ethylene-vinyl acetate rubber, and epichlorohydrin rubber.

The shape of the bottom portion of the outer frame body 5 may be any shape insofar as the action and the function of the expansion in the diameter direction and the contraction in the axial direction is satisfied. The shape may be a circular shape, an oval shape, an oval shape whose both ends have a wedge shape, a triangular shape, a rectangular shape, other polygons, or the like. Mentioned as required conditions is the condition such that the outer frame body 5 can be symmetrically pressed and expanded in the diameter direction. To that end, the shape of the bottom portion is suitably a rotationally symmetric body. Mentioned as a suitable shape is a circular shape as illustrated in FIG. 1B. This is because the distances from the central point are equal to each other, the outer frame body 5 can be symmetrically pressed in an arbitrary direction across the central point, and the like. The shape of the bottom portion may change to a certain degree along the axial direction. The shape of the bottom portion may vary in the central portion in the axial direction and in the output members at the ends in the axial direction.

As a suitable configuration of the outer frame body 5, a cylindrical structure having a circular bottom portion is mentioned and a structure in which the outer frame body 5 is formed by weaving the rigid fiber materials 12 can be mentioned.

With the configuration of the invention employing the outer frame body 5, the side surface whose area is overwhelmingly larger than the area of the bottom portion can be utilized for the area on which the deformation element 2 exerts force. Therefore, greater force can be generated as an actuator.

### Third Embodiment

In the actuator 1 described above, the shape of the deformation element 2 can be formed as in this embodiment.

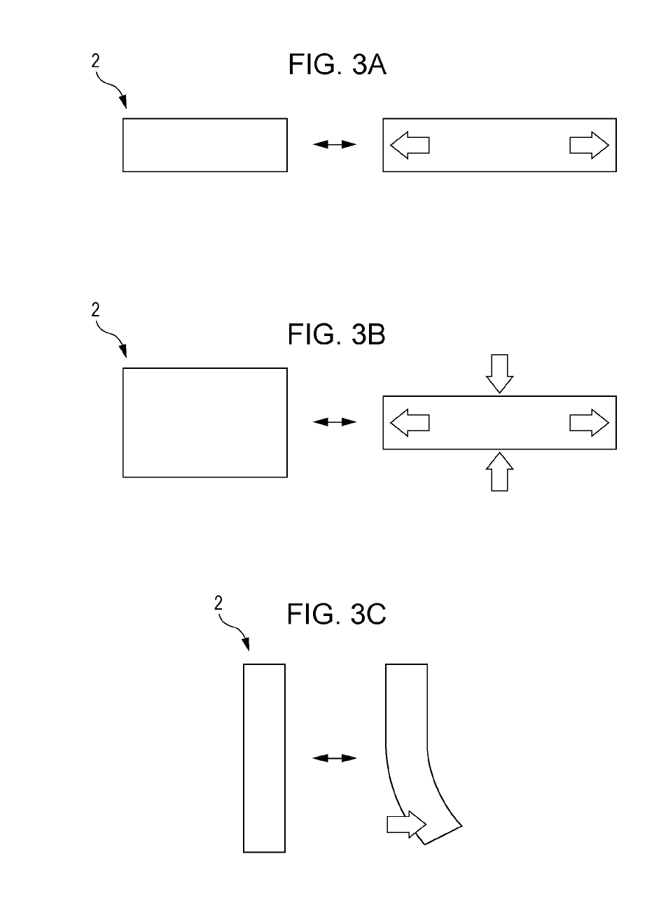

FIGS. 3A to 3C are schematic views illustrating the structure and an example of the action of the deformation element 2 usable in this aspect.

FIGS. 3A to 3C each illustrate the shape change behavior as a bulk, in which, in FIG. 3A, the bulk exhibits expansion deformation in at least one direction, in FIG. 3B, the bulk exhibits expansion deformation in at least one direction and simultaneously contraction deformation in a direction perpendicular to the direction, and, in FIG. 3C, the bulk exhibits bending deformation in at least one direction.

When the deformation element 2 which isotropically expands is used, the outer frame body 5 is pressed in the axial direction from the inside, which constitutes a factor of hindering the contraction action in the axial direction of the actuator 1. Therefore, it is suitable for the deformation element 2 to exhibit displacement of expanding in at least one direction of the diameter directions and not to exhibit displacement of expanding in the axial direction. Such a configuration can be achieved by the use of the deformation element 2 as illustrated in FIGS. 3A to 3C. It is more suitable for the deformation element 2 to exhibit displacement of expanding in at least one direction of the diameter directions and to exhibit displacement of contracting in the axial direction. Such a configuration can be achieved by the use of the deformation element 2 as illustrated in FIGS. 3B and 3C in the case of a single substance. Moreover, such a configuration can be achieved in FIGS. 3A to 3C also by the adjustment of the control by the power supply controller 8 or a structural device of unitization of the deformation elements 2.

The deformation element 2 exhibits deformation in response to electrical energization (voltage application). The deformation element 2 may be an element which exhibits deformation by the migration of ions, chemical changes, electrostriction, or heating as a result of energization.

Mentioned as a specific example of such a deformation element 2 is one in which the electric field is distorted by polarizing and changing the crystal structure as in a piezoelectric actuator. Moreover, mentioned are one in which the electric field is distorted by changing the volume by migration of ions as in an ion migration type polymer actuator and one in which the electric field is distorted by generating electrostatic force as in a dielectric elastomer type polymer actuator. Moreover, mentioned are one in which the electric field is distorted by changing the molecular orientation as in a liquid crystal actuator and one in which distortion is generated by causing phase transition of the crystal structure with the generation of heat (temperature change) due to energization as in a shape memory alloy. Moreover, mentioned is one in which distortion is generated due to thermal expansion with the generation of heat by energization as in a bimetal or a heat drive actuator. Moreover, mentioned is one in which distortion is generated by absorbing/discharging a solvent, such as moisture, in response to the input of electrical stimulus as in a hydrogel. Moreover, various kinds of aspects, such as one in which distortion is generated by storing/releasing hydrogen relative to a temperature region as in a hydrogen storage alloy material, can be mentioned.

For the unitization of the deformation elements 2, it is possible to employ a configuration, such as the formation of the deformation unit 3 through an intervention portion 10 as illustrated in FIG. 1B, the formation of the deformation unit group 4 by lamination of the deformation units 3 through a bonding portion 11 as illustrated in FIG. 1A, or the like.

The deformation elements 2 can be classified into one using expansion and contraction as a bulk as illustrated in FIGS. 3A and 3B and one using bending deformation as illustrated in FIG. 3C. Moreover, a configuration of performing bending deformation utilizing expansion and contraction as a bulk as in a unimorph element or a bimorph element which is generally known can also be considered.

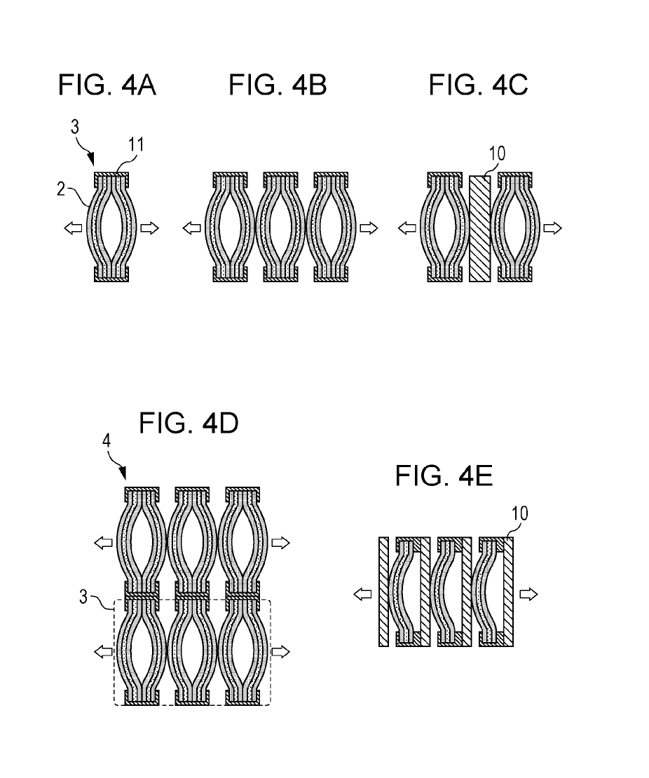

FIGS. 4A to 4E illustrate an exemplary structure of the deformation unit 3 and the deformation unit group 4 when the deformation element 2 exhibits bending deformation as illustrated in FIG. 3C.

FIG. 4A illustrates an exemplary structure of the deformation unit 3 obtained by combining the deformation elements 2.

As illustrated in FIG. 4A, two pieces of the deformation elements 2 are unitized through the bonding portion 11 to form the deformation unit 3. Then, by being controlled by the power supply controller 8 and the terminal 9 which are not illustrated, bending deformation is exhibited in a direction in which the deformation elements are separated from each other to generate displacement and force in the direction. The number of the deformation units 3 can be arbitrarily increased as illustrated in FIG. 4B. The deformation units 3 may have a configuration in which the deformation units 3 are continuously disposed without a space in the outer frame body 5 or a configuration in which a plurality of discontinuous units are disposed with a different member interposed therebetween. More specifically, as illustrated in FIG. 4C, the deformation units 3 may have a configuration in which the intervention portion 10 is disposed between the deformation elements 2. The intervention portion 10 is required to transmit the force caused by the bending of the deformation elements 2. Therefore, the intervention portion 10 suitably contains a rigid material and can be formed with various materials mentioned in the description of the fiber material 12, such as resin, glass, ceramics, and metals. The number of the intervention portions 10 may be arbitrarily selected.

The deformation units 3 move in such a manner as to be separated from each other in at least one direction of the diameter directions. It may be configured so that the deformation units 3 are combined in a plane in such a manner that an arbitrary number of the deformation units 3 move in an arbitrary direction in the diameter direction.

In FIG. 1B, as a suitable example, it is configured so that the deformation units 3 are disposed around the intervention portion 10 and force is applied in directions shifted by 90°. The deformation units 3 which perform bending action may be similarly disposed in such a manner as to be separated from each other. In order to increase the area on which force is exerted, it is more suitable that the deformation units 3 press the side surface of the outer frame body 5 symmetrically, uniformly, and entirely to a maximum extent.

By continuously disposing (laminating) the deformation units 3 in the axial direction as illustrated in FIG. 4D, the deformation unit group 4 can be formed.

In the deformation unit group 4, the direction of the displacement and the direction of the force of each of the deformation units 3 may be uniform or may be different from each other. Different deformation units 3 may be laminated.

As described in the description of the shape of the bottom portion of the outer frame body 5, it is important that the outer frame body 5 is symmetrically pressed in the diameter direction. Therefore, the generation of the displacement and the force of the deformation unit group 4 is suitably approximately symmetrical as a whole in an arbitrary direction.

It is not always necessarily to constitute the deformation unit group 4 by laminating the deformation units 3 and only one layer of the deformation unit 3 may be accommodated in the outer frame body 5.

The shape of the deformation element 2 may be any shape besides a long shape insofar as the deformation element 2 has the function of generating displacement and force in the bending direction due to bending action.

In addition to the structure such that the deformation elements open to be separated from each other as illustrated in FIG. 4A, any unitization manner may be acceptable. For example, even a configuration such that the deformation elements perform bending action in the same direction through the intervention portions 10 as illustrated in FIG. 4E can be applied.

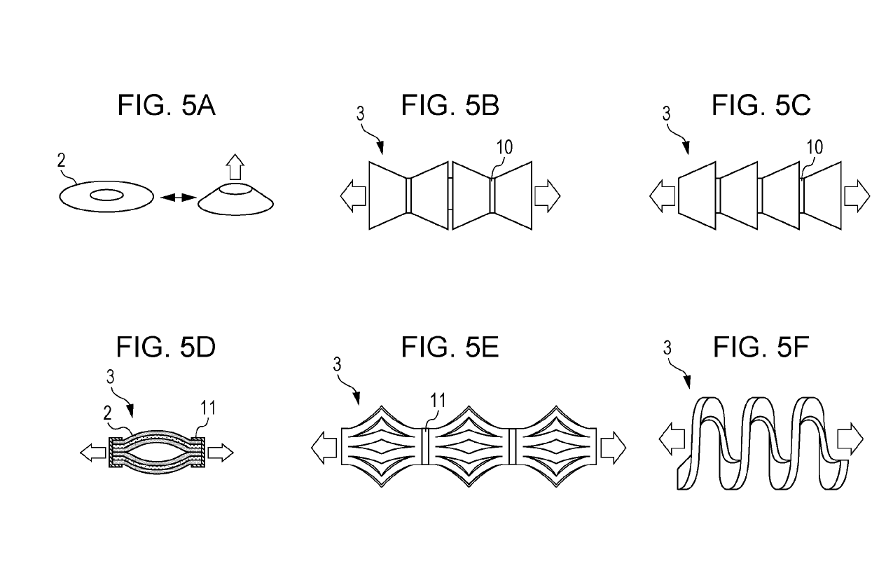

Moreover, an exemplary structure in which displacement and force are generated in a fixed direction by bending action as illustrated in FIGS. 5A to 5F may be employed. FIG. 5A illustrates a structure in which a disc-like deformation element is deformed into a cone shape by bending action. The displacement and the force are exhibited in the height direction of the cone, and the deformation unit 3 can be formed by accumulating the structures as illustrated in FIG. 5B or FIG. 5C. FIG. 5D illustrates a structure in which the direction of the displacement and the direction of the force are changed to a direction perpendicular to the direction of in FIG. 4A in the structure of FIG. 4A. By annularly connecting the structures as illustrated in FIG. 5E for unitization, the deformation unit 3 can be formed. FIG. 5F illustrates a structure with a spiral shape, in which displacement and force are generated toward the screw axis by bending. These structures can also be used.

In addition thereto, an employable structure is not limited to that of FIGS. 5A to 5F. Any aspect can be freely selected insofar as displacement and force are generated in at least one direction as the deformation element 2.

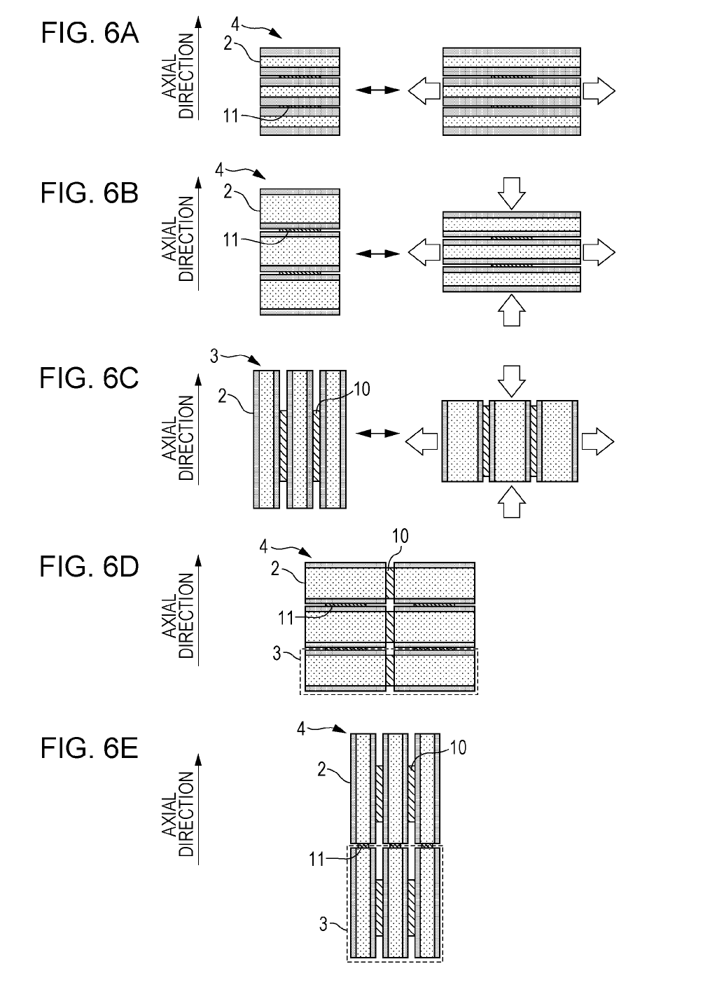

FIGS. 6A to 6E illustrates an exemplary structure of the deformation unit 3 and the deformation unit group 4 when the deformation element 2 exhibits expansion and contraction as a bulk as in FIGS. 3A and 3B. As a structural concept, a bending element which performs bending action illustrated in FIGS. 4A to 4E may be applied.

FIG. 6A illustrates an exemplary structure in a case where the deformation elements 2 exhibit expansion deformation in at least one direction as in FIG. 3A. The deformation elements 2 are laminated in such a manner that the expanding direction is set in the diameter direction of the actuator 1 to thereby constitute the deformation unit group 4 for use. In this case, the deformation units 3 may be considered to be the same as the deformation elements 2 or the deformation units 3 may be unitized through the intervention portions 10 as illustrated in FIG. 6D.

FIG. 6B illustrates an exemplary structure in a case where the deformation elements 2 exhibit expansion deformation in at least one direction and simultaneously contraction deformation in a direction perpendicular to the direction as illustrated in FIG. 3B. The deformation elements 2 are laminated in such a manner that the expanding direction is set in the diameter direction of the actuator 1 to thereby constitute the deformation unit group 4 for use. In this case, the deformation units 3 may be considered to be the same as the deformation elements 2 or the deformation units 3 may be unitized through the intervention portions 10 as illustrated in FIG. 6D.

FIG. 6C illustrates an exemplary structure in a case of using the deformation element 2 as illustrated in FIG. 3B whose initial state is different from that of FIG. 6B. In this case, the deformation elements 2 form the deformation units 3 through the intervention portions 10. The deformation group 4 may be considered to be the same as the deformation units 3 or the deformation units 3 may be unitized through bonding portions 11 as illustrated in FIG. 6E.

In order not to hinder the contraction action in the axial direction of the actuator 1, it is suitable for the deformation element 2 to exhibit displacement of expanding in at least one direction of the diameter directions and not to exhibit displacement of expanding in the axial direction. It is more suitable for the deformation element 2 to exhibit displacement of expanding in at least one direction of the diameter directions and to exhibit displacement of contracting in the axial direction. Therefore, it can be said that the configurations as illustrated in FIGS. 6B and 6C are more suitable.

As the shape of the deformation element 2, various shapes, such as a film shape, a tubular shape, a cylindrical shape, and a square pillar shape can be employed. These shapes may be arbitrarily combined.

With the configuration of the invention employing the deformation element 2, the surface of the outer frame body 5 on which the deformation element 2 exerts force is only the side surface, and the offset relationship which is observed in an air pressure actuator is not included, so that more efficient conversion of force and displacement can be achieved.

### Fourth Embodiment

An aspect is described below in which an ion migration type polymer actuator which performs bending action is applied to the deformation element 2 in the actuator 1 of the above-described embodiment.

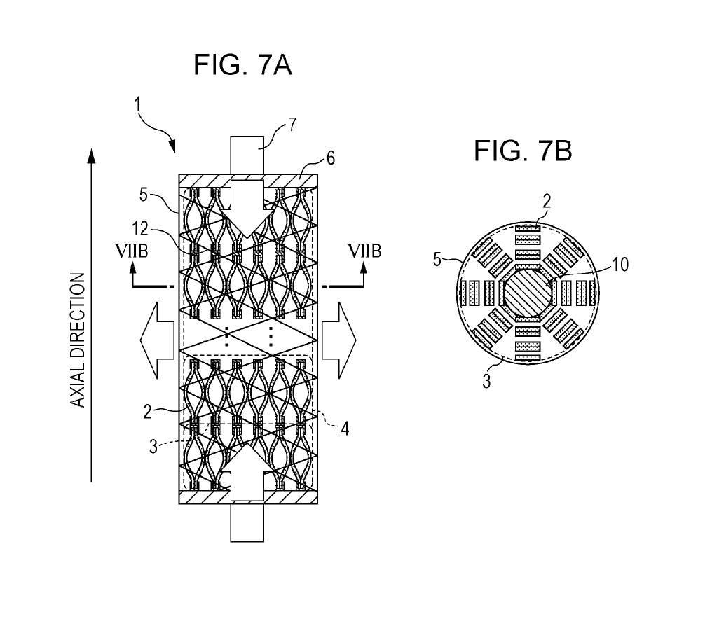

FIGS. 7A and 7B are views schematically illustrating the actuator 1 of the invention in which, FIG. 7A is a view schematically illustrating the entire structure thereof and FIG. 7B is a cross sectional view along the VIIB-VIIB line of FIG. 7A.

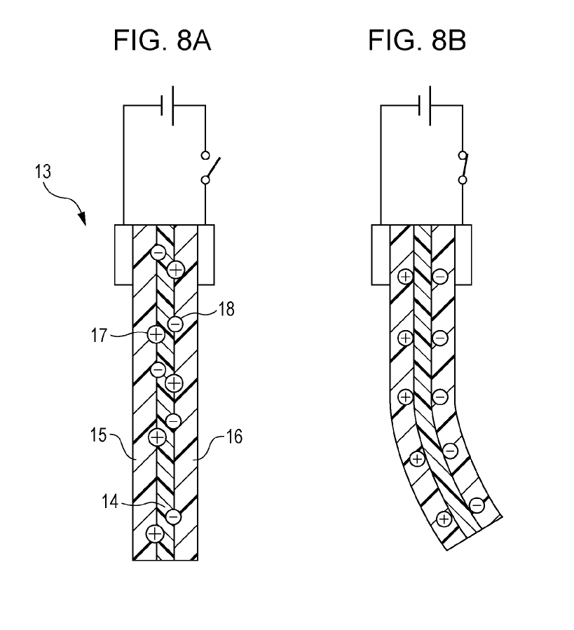

FIGS. 8A and 8B are views for describing the structure and the action of an ion migration type polymer actuator for use in the invention.

The actuator 1 of the invention has a structure of covering, with the outer frame body 5, the deformation unit group 4 in which the deformation units 3, in which a plurality of the deformation elements 2 are combined and which move in such a manner as to be separated from each other in at least one direction, are laminated as illustrated in FIGS. 7A and 7B. As illustrated in FIG. 2B, the outer frame body 5 has a structure in which the rigid fiber materials 12 are woven in the shape of a sheath, and, in response to the change in the woven angle of the fiber materials 12, the outer frame body 5 contracts in the axial direction when the outer frame body 5 expands in the diameter direction.

The output members 6 are disposed at both the ends of the actuator 1, and the output members 6 are bonded to the outer frame body 5 and output members at both the ends in the axial direction of the deformation unit group 4. At the central portion of the surface of each of the output members 6, a shaft portion 7 is provided. The actuator 1 and an external object are connected to each other with the shaft portions 7 to transmit displacement and force.

In the above-described configuration, the outer frame body 5 moves in such a manner as to expand in the diameter direction and simultaneously contract in the axial direction due to the fact that the outer frame body 5 is pressed and expanded from the inside by the deformation unit group 4. Thus, due to the fact that the outer frame body 5 converts the force and the displacement in the diameter direction of the deformation unit group 4, the actuator 1 generates force and displacement in the axial direction.

The structure of an ion migration type polymer actuator 13 which is the deformation element 2 is a structure in which an electrolyte layer 14 is held by a first electrode layer 15 and a second electrode layer 16 as illustrated in FIGS. 8A and 8B. The electrolyte layer 14 and the first and second electrode layers 15 and 16 contain ions (cations 17, anions 18) which are electrolyte components. When a voltage is applied to the ion migration type actuator 13, the ions move in response to the electric field, so that the cations 17 move to the cathode side and the anions 18 move to the anode side. In response to a volume change and a volume difference of the first and second electrode layers 15 and 16 caused by the movement of the cations and the anions, the ion migration type polymer actuator 13 exhibits bending action. FIGS. 8A and 8B illustrate a phenomenon in which the volume of the first electrode layer 15 to which the cations 17 move has become larger than the volume of the second electrode layer 16.

The first electrode layer 15 and the second electrode layer 16 of the ion migration type polymer actuator 13 are formed with a polymer material having conductivity. Mentioned as the polymer material having conductivity are polymer complexes containing a conductive polymer or a conductor.

The conductive polymer is not particularly limited, and, for example, conductive polymer materials, such as polyaniline, polypyrrole, polythiophene, polyacetylene, and polyphenylene can be mentioned.

Mentioned as the conductor for use in the polymer complexes are conductors, such as: various carbon materials, such as black lead, carbon black, acetylene black, Ketjenblack, carbon whisker, carbon fiber, carbon nanotube, and carbon microcoil, powder (fine particles) of metals (e.g., gold, platinum, palladium, ruthenium, silver, iron, cobalt, nickel, copper, indium, iridium, titanium, and aluminum), metallic compounds (e.g., tin oxide, zinc oxide, indium oxide, stannic oxide, and ITO), metal fibers, and conductive ceramics materials. These conductors are contained singly or as a mixture in the polymer complexes.

Polymers containing the conductors are not particularly limited insofar as the polymers have flexibility which allows the polymer to follow the action of the actuator, and are suitably polymers which have little hydrolysis properties and are stable in the atmosphere.

As such polymers, polyolefin polymers, such as polyethylene and polypropylene; polystyrene; polyimide; polyarylenes (aromatic polymers), such as polyparaphenylene oxide, poly(2,6-dimethylphenylene oxide), and polyparaphenylene sulfide; polymers into which a sulfonic acid group (—SO₃H), a carboxyl group (—COOH), a phosphate group, a sulfonium group, an ammonium group, and a pyridinium group are introduced, such as a polyolefin polymer, polystyrene, polyimide, and polyarylenes (aromatic polymers); fluorine containing polymer, such as polytetrafluoroethylene and polyvinylidene fluoride; a perfluorosulfonic acid polymer, a perfluorocarboxylic acid polymer, and a perfluorophosphoric acid polymer in which a sulfonic acid group, a carboxyl group, a phosphate group, a sulfonium group, an ammonium group, a pyridinium group, and the like are introduced into the skeleton of fluorine containing polymers; a polybutadiene compound; a polyurethane compound, such as an elastomer or a gel; a silicone compound; polyvinyl chloride; polyethylene terephthalate; nylon; polyarylate; and the like can be mentioned.

Although the polymer material containing a conductor can be formed by combining the conductors and the polymers mentioned above, a plurality of the conductors and a plurality of the polymers may be mixed and combined.

Or, the conductive polymer materials and the conductors mentioned above may be combined for use.

These electrode materials may contain an electrolyte described later in the formation thereof.

The polymer is suitably a polymer having a high compatibility with the electrolyte layer 14. Due to the fact that the compatibility and the bonding property with the electrolyte layer 14 are high, a firmly stuck actuator can be formed. Therefore, the polymer is suitably a polymer having the same kind of a polymer structure as, a similar polymer structure to, or the same polymer structure as the polymer structure of the polymer compound constituting the electrolyte layer 14 or a polymer having the same kind of a functional group as, a similar functional group to, or the same functional group as that of the polymer compound constituting the electrolyte layer 14.

At least one of the electrode layers 15 and 16 may be formed as a layer containing only metal. When directly forming such an electrode layer on the electrolyte layer, it may be considered that the electrode is formed only with a conductive material. As these metal layers, materials, such as gold, platinum, palladium, ruthenium, silver, iron, cobalt, nickel, copper, indium, iridium, titanium, and aluminum, are mentioned. These layers may be formed as a thin metal layer by plating, vapor deposition, sputtering, or the like.

As a particularly suitable aspect, it is suitable to use, for an actuator electrode, a bucky gel obtained by mixing a carbon nanotube with a polyvinylidene fluoride-hexafluoropropylene copolymer [PVDF (HFP)] or polymer of polyvinylidene fluoride (PVDF) and ionic liquid to form a gel. The first and second electrode layers may be formed with the same material or different materials.

The electrolyte layer 14 may have a configuration in which a potential difference can be applied between the first and second electrode layers and is suitably constituted by a polymer material holding an electrolyte. Mentioned as a suitable composition of the electrolyte layer is a material having flexibility which contains an electrolyte (i.e., a substance exhibiting ionicity in a molten state) and a polymer matrix material for holding the layer structure. Mentioned as the material constituting the electrolyte layer is a nonionic polymer compound containing an ionic substance or an ion conductive polymer compound. With these materials, when charges move in the presence of an electric field and a current flows, ions serve as a carrier of the charges. Due to the fact that the ions move to either one or both of the electrode sides and localized, the localized portion expands, which generates deformation as the entire polymer actuator. In the invention, the first and second electrode layers and the electrolyte layer are formed with polymer materials having flexibility. Therefore, due to the fact that deformation occurs in at least one of the members, the remaining members also follow the deformation to be deformed.

As the polymer, fluorine containing polymers, such as tetrafluoroethylene and polyvinylidene fluoride; polyolefin polymers, such as polyethylene and polypropylene; a polybutadiene compound; a polyurethane compound, such as an elastomer or a gel; a silicone compound; a thermoplastic polystyrene; polyvinyl chloride; polyethylene terephthalate; and the like can be mentioned. These polymers may be used singly or in combination of two or more kinds thereof, a functional group may be modified, or a copolymer may be formed with another polymer.

As the ionic substances contained in these polymers, lithium fluoride, lithium bromide, sodium bromide, magnesium chloride, copper sulfate, sodium acetate, sodium oleate, and sodium acetate can be mentioned, for example.

The ionic substance suitably contains tetrafluoroboric acid ion, hexafluorophosphoric acid ion, trifluoromethanesulfonic acid ion, ion of bis(trifluoromethylsulfonyl)imide or tris(trifluoromethylsulfonyl)imide, ion of bis(trifluoromethylsulfonyl)methide or tris(trifluoromethylsulfonyl)methide, or salts thereof. Used as a counter ion thereof are lithium, sodium, and the like.

When ionic liquid is used as the ionic substance, the durability in a drive in air is improved. Therefore, the use of the ionic liquid is suitable.

Herein, the ionic liquid is also referred to as a room temperature molten salt or simply referred to as a molten salt and is a salt which exhibits a molten state in a wide temperature region including normal temperature (room temperature) and is a salt which exhibits a molten state at, for example, 0° C., suitably −20° C., and more suitably −40° C. As the ionic liquid, one having ion conductivity is suitable. For the ionic liquid, known various kinds of ionic liquid can be used and a stable ionic liquid which exhibits a liquid state in the actual use temperature region is suitable. As a suitable ionic liquid, imidazolium salt, pyridinium salt, ammonium salt, and phosphonium salt are mentioned and these salts may be used singly or as a mixture.

As the electrolyte layer 14 of the invention, one in which the ionic liquid is used as the electrolyte and a polyvinylidene fluoride-hexafluoro propylene copolymer [PVDF (HFP)] or polyvinylidene fluoride (PVDF) is used as the polymer is suitably mentioned.

In order to achieve good adhesiveness with the electrode layers (15, 16), it is also suitable to utilize the polymer materials for use in the electrode layers as a matrix material of the electrolyte layer.

An exemplary structure in which ion migration type polymer actuators 13 which are the deformation elements 2 are combined to form the deformation unit 3 is illustrated in FIGS. 4A to 4E.

As illustrated in FIG. 4A, the two ion migration type polymer actuators 13 are unitized through the bonding portion 11 to form the deformation unit 3. Then, by energizing by the power supply controller 8 which is a voltage/current controller and the terminal 9 which is an electrical wiring line which are not illustrated, distortion deformation is exhibited in the direction in which the actuators are separated from each other to generate displacement and force in the direction.

In FIG. 7B, as a suitable example, it is configured so that the deformation units 3 are disposed around the intervention portion 10 in such a manner as to be separated from each other in directions shifted by 45°. In order to increase the area on which force is exerted, it is more suitable that the deformation units 3 press the side surface of the outer frame body 5 symmetrically, uniformly, and entirely to the maximum extent.

By laminating the deformation units 3 as illustrated in FIG. 4D, the deformation unit group 4 can be formed.

The shape of the ion migration type polymer actuator 13 which is the deformation element 2 may be any shape besides a long shape insofar as the actuator has the function of generating displacement and force in the bending direction due to bending action.

In addition to the structure such that the deformation elements open to be separated from each other as illustrated in FIGS. 7A and 7B, any unitization manner may be acceptable insofar as bending action is performed, such as the exemplary structure illustrated in FIGS. 5A to 5F.

The size of the actuator 1 of the invention can be suitably selected according to the intended use. For example, an actuator having a cross section with a diameter of 1 mm to several tens of cm and a size in the axial direction of 1 mm to several tens of cm can be produced.

The size of the deformation element 2 disposed inside can be suitably selected according to the size of the expansion and contraction actuator 1 described above. Similarly, the size of the deformation unit 3 and the deformation unit group 4 can also be suitably selected according to the size of the expansion and contraction actuator 1 described above.

Hereinafter, the actuator 1 of the invention is described with reference to specific examples of the shape and the characteristics.

Herein, the actuator 1 has a structure of having the cylindrical outer frame body 5 with a diameter D [cm] and a height L [cm] and fiber materials 12 wound over the outer frame body 5 to both the ends thereof. One fiber material 12 is wound with a length b [cm] and with n turns and the woven angle of the fiber material 12 to the axial direction is θ₀ [° ] in the initial state.

Herein, it is assumed that a bulk is disposed in the outer frame body 5 for convenience of structural calculation. The force which the bulk applies to the outer frame body 5 is defined as F′ [N] or P [N/cm²] and the expansion amount in the diameter direction of the bulk is defined as ρ [%]. Due to the fact that the outer frame body 5 is pressed in the diameter direction from the inside by the bulk, the woven angle of the fiber materials 12 is changed to θ′ [° ] and simultaneously the outer frame body 5 contracts by ∈ [%] in the axial direction. Moreover, the force of F [N] at the maximum is generated as blocking force in the contraction direction of the axis. Herein, the blocking force means the size of the force in a state where the generation of distortion of the actuator is suppressed. In such a state, since the work that the actuator performs is all converted to force, the force may be considered as the maximum generative force of the actuator.

Herein, first, it is assumed that the bulk disposed inside is air in contrast to the actuator 1 of the above-described configuration. As the structural calculation as an air pressure actuator, NPL 1 can be referred to, for example.

dWᵢₙ which indicates the work performed by air inside is expressed by dWᵢₙ [N*cm]=P [N/cm²]*dV [cm³] when the volume change of the outer frame body 5 is defined as dV. dWₒᵤₜ which indicates the work performed to the outside as the actuator 1 is expressed by dWₒᵤₜ [N*cm]=−F [N]*dL [cm] when the expansion and contraction amount in the axial direction is defined as dL.

When dWᵢₙ is equal to dWₒᵤₜ (dWᵢₙ=dWₒᵤₜ) assuming that there is no conversion loss, and the relationship of the force F in the axial direction of the actuator 1 from the woven angle θ₀ and the contraction amount ∈ in the axial direction is determined, Equation (1) is obtained.

$$\begin{matrix}[ Math . 1 ] & \\ F = \frac{π {D}_{0}^{2} P}{4} ( \frac{3}{{tan}^{2} {θ}_{0}} {( 1 - ɛ )}^{2} - \frac{1}{{sin}^{2} {θ}_{0}} ) & Equation ( 1 )\end{matrix}$$

The relationship of the contraction amount ∈ in the axial direction and the expansion amount ρ in the diameter direction of the actuator 1 at the woven angle θ′ after deformation is expressed by Equation (2).

$$\begin{matrix}[ Math . 2 ] & \\ ɛ = \frac{( ρ + 1 ) cos {θ}^{′}}{\sqrt{{( ρ + 1 )}^{2} - {sin}^{2} {θ}^{′}}} - 1 & Equation ( 2 )\end{matrix}$$

Next, the case where the bulk disposed inside presses only the side surface of the outer frame body 5 as in the invention is considered.

dWᵢₙ which indicates the work performed by the bulk inside is expressed by dWᵢₙ [N*cm]=F′ [N]*dD [cm] when the force with which the bulk presses the side surface is defined as F′ and the change amount of the diameter of the outer frame body 5 is defined as dD. dWₒᵤₜ which indicates the work performed to the outside as the actuator 1 is expressed by dWₒᵤₜ [N*cm]=−F [N]*dL [cm] when the expansion and contraction amount in the axial direction is defined as dL.

When dWᵢₙ is equal to dWₒᵤₜ (dWᵢₙ=dWₒᵤₜ) assuming that there is no conversion loss, and the relationship of the force F in the axial direction of the actuator 1 from the woven angle θ₀ and the contraction amount ∈ in the axial direction is determined, Equation (3) is obtained.

$$\begin{matrix}[ Math . 3 ] & \\ F = \frac{{F}^{′} cos {θ}_{0}}{n π sin {θ}_{0}} ( 1 - ɛ ) & Equation ( 3 )\end{matrix}$$

The relationship of the contraction amount ∈ in the axial direction and the expansion amount ρ in the diameter direction of the actuator 1 at the woven angle θ′ after deformation is expressed by Equation (2) similarly as in the case where air is used for the bulk.

Now, with respect to the shape of the outer frame body 5 of the actuator 1, the diameter D of the bottom portion is set to 1.2 cm and the length L in the axial direction is set to 6 cm. The blocking force (the maximum generative force) in the axial direction of the actuator 1 is set to 565 N. More specifically, the actuator 1 requires the force of 500 N/cm² for the cross section (bottom portion) perpendicular to the axial direction. The maximum contraction amount in the axial direction of the actuator 1 is 30% to the full length. When the contraction amount of the actuator 1 is regarded as the contraction amount of the outer frame body 5, this means that the outer frame body 5 contracts by 1.8 cm.

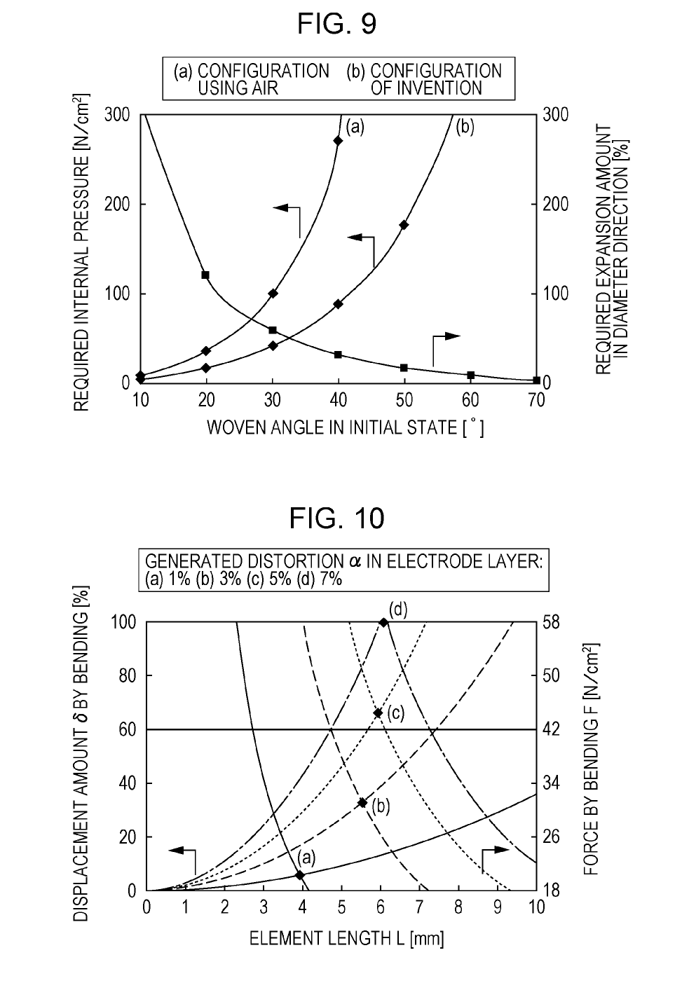

The results of determining the relationship of the expansion amount in the diameter direction of the bulk disposed inside and the force which are required in order for the actuator 1 to satisfy the above-described characteristics to the woven angle θ₀ in the initial state are illustrated in FIG. 9.

FIG. 9 illustrates the case (a) where air is used as a bulk and the case (b) where a configuration in which the only the side surface is pressed as in the invention is used as a bulk.

The expansion amount and the force required as a bulk change in a trade-off relationship to the woven angle θ₀ in the initial state. It is found that the required force in the configuration (b) of the invention is always lower than that in the configuration (a) using air.

In the configuration (a) using air, the force is generated by contraction in the axial direction as a whole, but, inside, the force is applied in such a manner as to expand in the axial direction. Therefore, the internal force and the force to be extracted to the outside are offset each other, and an inefficient portion is included. In contrast, in the configuration (b) of the invention, the surface where the internal bulk exerts force is only the side surface, and the offset relationship observed in the structure (a) is not included, so that the force can be more efficiently converted.

When the woven angle in the initial state was set to 30°, the required force of the bulk was 100 N/cm² in the configuration (a) using air as a bulk and, in the configuration (b) of the invention in which only the side surface is pressed as a bulk, the required force of the bulk was 42 N/cm². The required expansion amount in the diameter direction was 60% of the diameter of the outer frame body 5 in both the configurations (a) and (b).

In contrast, supposing that the outer frame body 5 as in the invention is not used and the bulk disposed inside directly applies force in the axial direction, the required force as a bulk is similarly 500 N/cm². The contraction amount required as a bulk is 30% of the length in the axial direction of the outer frame body 5.

Thus, by utilizing the side surface whose area is overwhelmingly larger than the area of the bottom portion, the force required for per area as a bulk can be further reduced relative to the force required as the actuator 1. In other words, even when the force is equivalent as a bulk, greater force can be generated as the actuator 1 by employing the structure of the invention.

Moreover, according to the configuration of the invention, the surface on which the internal bulk exerts force is only the side surface, and an offset relationship observed in the air pressure actuator is not included, so that more efficient conversion of force and displacement can be achieved.

The structural calculation of the ion migration type polymer actuator 13, which is the deformation element 2, which achieves the structural calculation of the actuator 1 is described below.

As the ion migration type polymer actuator 13, one having a three-layer structure of an electrode layer/an electrolyte layer/an electrode layer and a long shape as illustrated in FIGS. 8A and 8B is considered. As the first and second electrode layers, the same electrode layer is used. One end of both the ends in the length direction of the ion migration type actuator 13 is fixed as a fixed end the other end thereof exhibits bending deformation as a free end.

With respect the structural calculation of the bending deformation of such an ion migration type polymer actuator 13, NPL 2 can be referred to, for example.

The thickness of the first and second electrode layers is defined as h₁ [mm], the thickness of the electrolyte layer is defined as h₂ [mm], the Young's modulus of the first and second electrode layers is defined as E₁ [MPa], the Young's modulus of the electrolyte layer is defined as E₂ [MPa], the width of the first and second electrode layers and the electrolyte layer is defined as b [mm], the length of the element from the fixed end is defined as L [mm], the bending amount of the free end which exhibits bending deformation (the displacement amount in the film thickness direction) is defined as δ [mm], the radius of curvature of bending is defined as R [mm], the distortion generated in the electrode layer is defined as α, and the force applied to the free end which exhibits bending deformation is defined as F [N].

The distortion α generated in the electrode layer of the ion migration type actuator 13 is expressed by Equation (4) and the force F applied to the free end which indicate bending deformation is expressed by Equation (5).

$$\begin{matrix}[ Math . 4 ] & \\ α = - \frac{EI}{{RE}_{1} {bh}_{1} ( {h}_{1} + {h}_{2} )} & Equation ( 4 ) \\ [ Math . 5 ] & \\ F = \frac{{E}_{1} b α {h}_{1} ( {h}_{1} + {h}_{2} )}{L} & Equation ( 5 )\end{matrix}$$

EI in Equation (4) indicates the product of the Young's modulus and the geometric moment of inertia of the ion migration type actuator 13 and has the relationship of EI=E₁*(Geometric moment of inertia of the electrode layer)+E₂*(Geometric moment of inertia of the electrolyte layer). The displacement amount δ and the radius of curvature R have the relationship expressed by Equation (6).

$$\begin{matrix}[ Math . 6 ] & \\ \frac{1}{R} = \frac{2 δ}{{L}^{2} + {δ}^{2}} & Equation ( 6 )\end{matrix}$$

Herein, the thickness h₁ of the electrode layer is set to 1 mm, the thickness h₂ of the electrolyte layer is set to 0.05 mm, the Young's modulus E₁ of the electrode layer is set to 300 MPa, the Young's modulus E₂ of the electrolyte layer is set to 100 MPa, and the width b of the element is set to 1 mm. The length L of the element is set to 0 mm to 10 mm. The relationship of the force F and the displacement amount δ to the length L of the element when the distortion α generated in the electrode layer is set to 1%, 3%, 5%, and 7% is determined using Equations (4), (5), and (6), and FIG. 10 illustrates the relationship. In FIG. 10, the displacement amount δ is indicated as a value to the film thickness of the ion migration type polymer actuator 13. More specifically, when the displacement amount corresponding to the film thickness of the element is obtained, it is supposed that δ is 100%. The force F indicates the force per area divided by the element area of the ion migration type polymer actuator 13.

In order for the actuator 1 of the above-described size to produce the maximum generative force of 565 N and the maximum contraction amount of 30%, it has been required to pressurize the side surface at 42 N/cm² as a bulk disposed inside to expand the actuator 1 by 60% in the diameter direction.

FIG. 10 shows that these requirements are satisfied as a bulk when the generated distortion α in the electrode layer is a little less than 5%.

Conductive polymers, such as polypyrrole and polyaniline, are known to exhibit expansion and contraction of several % to several tens of % due to an electrochemical volume change with the migration of ions. The use of such a material as the electrode layer of the ion migration type polymer actuator 13 allows the production of the ion migration type polymer actuator 13 which satisfies the structural calculation.

Since the value of the required generated distortion α in the electrode layer can be reduced depending on the generative force of the actuator 1, a known ion migration type polymer actuator can be used irrespective of the conductive polymer.

Suitably, an ion migration type polymer actuator is mentioned which employs a composite gel of a carbon material, such as a carbon nanotube, an ionic liquid, and a polymer serving as a binder for the electrode layer. This is because a part of the action principle of the action between the electrode layer and ions is based on not a secondary battery type oxidation-reduction reaction but an electric double layer capacitor type ion migration, and therefore such an actuator has high durability and is suitable for repeated use because.

Moreover, the structure of the actuator 1 can be designed according to the specification of the ion migration type polymer actuator 13 to be used.

Moreover, the division of the bulk, i.e., the deformation and unitization of the ion migration type polymer actuator 13, may be freely selected irrespective of the above-mentioned size.

Although force is exerted throughout the side surface in the case of the bulk, the deformation unit 3 of the ion migration type polymer actuator 13 requires consideration of the presence of a dead space. However, it is a problem which arises even when pressing only the cross section (bottom portion) perpendicular to the axial direction of the actuator 1, and it can be said that the influence is relatively small at least in the actuator 1 utilizing the deformation unit 3.

According to the configuration of the invention, greater force than the required force as the actuator 1 can be generated as the actuator 1 by utilizing the side surface whose area is overwhelmingly larger than the area of the bottom portion.

Moreover, according to the configuration of the invention, the surface on which force is exerted is only the side surface and the offset relationship observed in an air pressure actuator is not included, so that a more efficient conversion of force and displacement can be achieved.

Moreover, a large-scale gas pressure control device or the like which is provided in an air pressure actuator is not required, so that the invention can provide a lighter weight and smaller actuator.

(Comparison of Characteristic with Actuator of Invention)

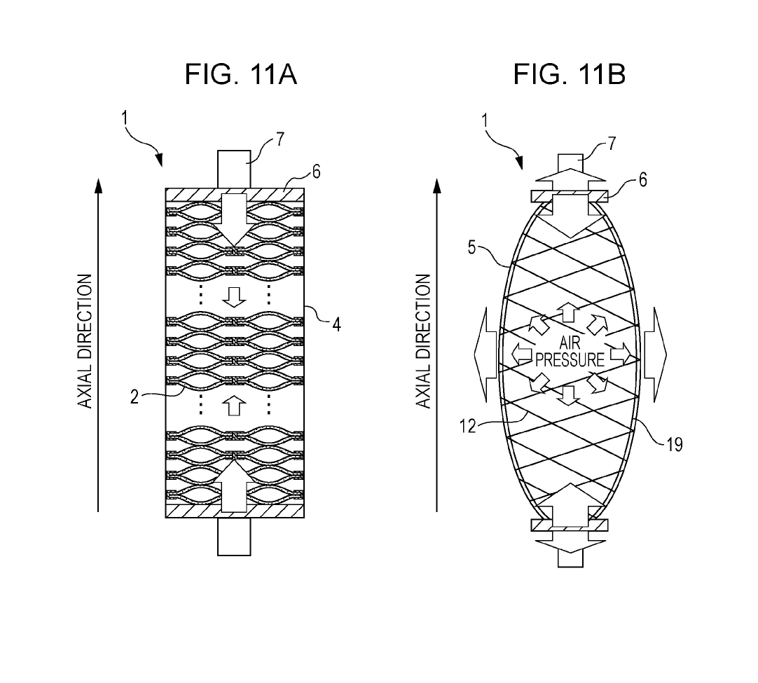

As a first comparative aspect to the configuration of the fourth embodiment of the invention, the structure illustrated in FIG. 11A can be mentioned. In FIG. 11A, the outer frame body 5 as in the invention is not provided and the deformation unit group 4 directly applies displacement and force in the axial direction. The deformation unit group 4 is one obtained by accumulating the deformation elements 2 which exhibit bending deformation described in the fourth embodiment.

In such a configuration, the area on which the deformation unit group 4 exerts force is limited only to the cross section (bottom portion) perpendicular to the axial direction of the actuator 1. Therefore, when the deformation unit group 4 is considered as a bulk, the force per area required as a bulk become very great.

As illustrated in FIG. 9, when the actuator 1 is formed into a cylindrical shape with a diameter of 1.2 cm and a length of 6 cm and with the maximum generative force of 565 N, the force required as a bulk is 42 N/cm² in the fourth embodiment (Woven angle in the initial state: 30°) of the invention but is 500 N/cm² in the first comparative aspect.

When considering the fact that when the required force is greater, the technical difficulty further increases, the superiority of the configuration of the invention is clear.

As a second comparative aspect to the structure of the fourth embodiment of the invention, the structure illustrated in FIG. 11B can be mentioned. In FIG. 11B, the outer frame body 5 is provided similarly as in the invention but the deformation unit group 4 is not disposed inside but fluid (air) is supplied. In order to prevent the leak of air and to transmit the air pressure to the outer frame body 5, a tube 19 is accommodated inside the outer frame body 5. The tube 19 expands by the supply of air to press and expand the outer frame body 5 in the diameter direction, so that the outer frame body 5 contracts in the axial direction as a whole to thereby generate force.

In such a configuration, air isotropically gives force to the outer frame body 5. Unlike the first comparative aspect, the side surface having a large area can be utilized. Therefore, when the force required as the actuator 1 is the same, the internal pressure required as a bulk can be further reduced. However, the actuator 1 contracts in the axial direction as a whole to thereby generate force but, inside the actuator, there is a portion in which force is applied in such a manner as to expand in the axial direction. Therefore, the internal force and the force to be extracted to the outside offset each other, and an inefficient portion is included.

As illustrated in FIG. 9, when the actuator 1 is formed into a cylindrical shape with a diameter of 1.2 cm and a length of 6 cm and with the maximum generative force of 565 N, the force required as a bulk is 42 N/cm² in the fourth embodiment (Woven angle in the initial state: 30°) of the invention but is 100 N/cm² (The woven angle in the initial state is similarly set to 30°.) in the second comparative aspect.

When considering the fact that when the required force is greater, the technical difficulty further increases, the superiority of the configuration of the invention is clear.

Moreover, according to the fourth embodiment of the invention, a large-scale gas pressure control device or the like which is provided in an air pressure actuator is not required, so that a lighter weight and smaller actuator can be provided.

### Fifth Embodiment

In the above-described actuator 1, an interlayer transmission member 21 can be formed between the deformation element unit 3 and the outer frame body 5 as in this embodiment.

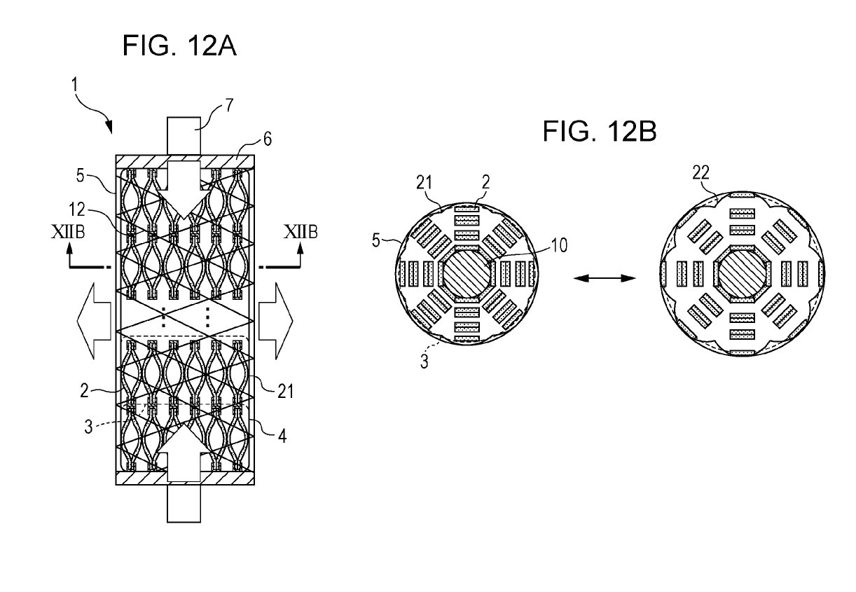

FIGS. 12A and 12B are schematic views illustrating the structure and an example of the action of the interlayer transmission member 21 which can be used in this aspect, in which FIG. 12A is a view schematically illustrating the entire configuration thereof and FIG. 12B is a cross sectional view along the XIIB-XIIB line of FIG. 12A and illustrates the action of the interlayer transmission member to deformation.

The case where the deformation units 3 are configured in such a manner as to be separated from each other in directions shifted by an arbitrary angle as illustrated in FIG. 7B is considered. Although it is suitable for the deformation unit 3 to press the side surface of the outer frame body 5 symmetrically, uniformly, and entirely to the maximum extent but a region having no contact surface is inevitably generated therebetween. Due to the fact, there is a possibility that the pressure applied to the outer frame body 5 becomes partially nonuniform.

The interlayer transmission member 21 for use in this aspect is present between the deformation units 3 and the outer frame body 5, is disposed in such a manner as to fill the regions having no contact surface, and approximately uniformly transmits the pressure in the diameter direction exerted by the deformation units 3 to the outer frame body 5.

The interlayer transmission member 21 is suitably a member having rigidity with which the interlayer transmission member 21 itself is not greatly deformed by the pressure applied between the deformation unit 3 and the outer frame body 5.

In addition, it is suitable for the interlayer transmission member 21 to have a variable structure with which the interlayer transmission member 21 can follow the expansion and contraction in the diameter direction of the deformation unit 3 and the outer frame body 5. Specifically, as illustrated in FIGS. 12A and 12B, a rigid member is disposed on the surface contacting at least the deformation unit 3 and a connection member 22 having expansion and contraction properties is disposed on the surface not contacting the deformation unit 3.

As such a rigid member, various metals, various plastics, various ceramics, and the like can be suitably selected. As the member having expansion and contraction properties, substances having elasticity and flexibility as raw materials of various rubbers or substances having expansion and contraction properties as a structure even when the substance is a rigid material, such as a spring, can be suitably selected.

The interlayer transmission member for use in this aspect may have any structure insofar as the structure has the same function as that described above.

The interlayer transmission member 21 of this aspect is equivalent to the tube 19 used in an air pressure actuator in terms of the function. The tube 19 needs to have a sealed structure in order to prevent the leak of fluid (air). However, the interlayer transmission member 21 in this aspect does not need to have a sealed structure. The interlayer transmission member 21 has advantages in that the interlayer transmission member 21 is not so limited in the structure and easily follows the expansion and contraction in the diameter direction due to the presence of a member having expansion and contraction properties which allows deformation, for example.

### Sixth Embodiment

In the actuator 1 of the above-described embodiments, the deformation unit disposed inside can also be formed as in this embodiment by designing the terminal structure of the output members 6 and 20 and the outer frame body 5.

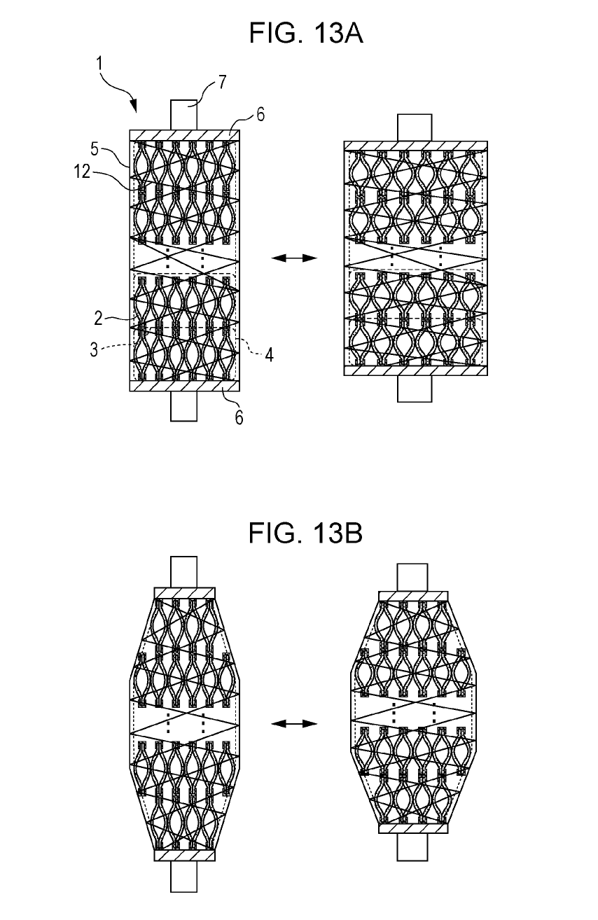

FIGS. 13A and 13B are schematic views illustrating the terminal structure usable in this aspect.

In the actuator 1, the outer frame body 5 collects the pressure in the diameter direction to the deformation unit 3 to the output members 6 and 20. Therefore, the output members 6 and 20 and the outer frame body 5 employ a structure in which at least one part thereof is bonded.

As an example of the terminal structure with the drive of the actuator 1, the structure in which the output members follow the change in the diameter direction of the outer frame body as illustrated in FIG. 13A and the structure in which the output members do not follow the change in the diameter direction of the outer frame body and in which the outer frame body is tapered to the ends as illustrated in FIG. 13B can be considered.

In FIG. 13A, the diameter of the outer frame body 5 is approximately uniform in the length direction irrespective of before and after drive. Therefore, the deformation units 3 to be disposed inside is not required to be greatly changed in the length direction of the outer frame body 5, and thus it is considered that the same units can be disposed. The deformation unit 3 can be modularized and mounted on the actuator 1, and therefore has merits in the cost or the productivity.

As such an output member, one having elasticity and flexibility as raw materials of various rubbers or one having expansion and contraction properties as a structure even when it is a rigid material, such as a spring, can be suitably selected. Moreover, a structure is suitable which follows expansion and contraction in the diameter direction but is not deformed in the axial direction.

In FIG. 13B, a shape is formed in which the diameter of the outer frame body 5 becomes larger toward the center in the length direction and the diameter becomes smaller toward both ends before and after drive. Since the expansion and contraction ratio in the diameter direction of the outer frame body 5 varies in the length direction, the deformation unit 3 requires a contrivance, such as the adjustment of the number of the deformation elements 2 present in the unit in the length direction of the outer frame body 5. In contrast, since the output member itself may be formed with an undeformable rigid member, the output member can be formed into a member integrated with the shaft portion 7. When the output members are deformed as illustrated in FIG. 13A, a part of the pressure of the deformation unit 3 is required for the deformation of the output members. However, in this case, since the pressure is not required, the loss of force relating to the output member can be suppressed, so that the force in the diameter direction can be more directly converted to the force in the axial direction.

### Seventh Embodiment

In the actuator 1 of the above-described embodiments, the electrical connection of the deformation element 2 and the deformation unit 3 and the power supply controller 8 can be established as in this embodiment.

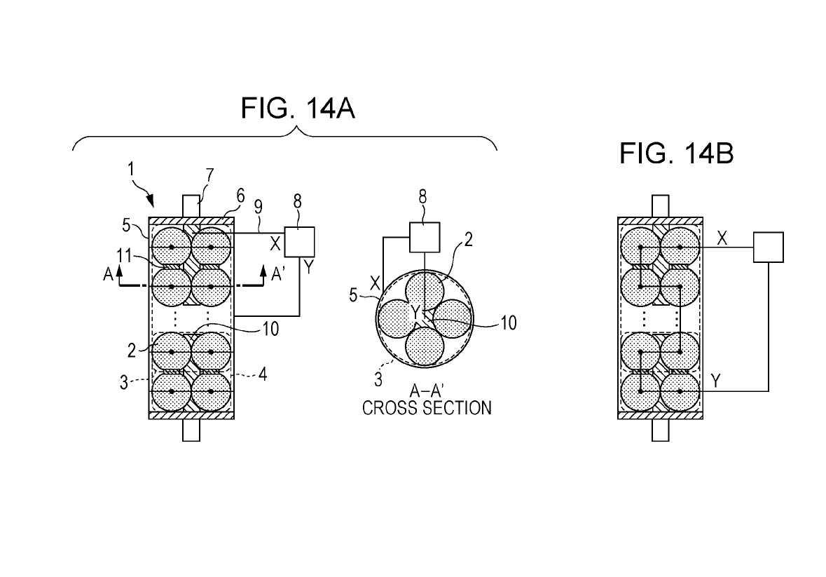

FIGS. 14A and 14B are schematic views illustrating electrical connection usable in this aspect, in which FIG. 14A is a schematic view illustrating the case where the electrical connection of the deformation units is established in parallel and FIG. 14B illustrates the case where the electrical connection of the deformation units is established in series.

In FIG. 14A, the outer frame body 5 (or the interlayer transfer member 21) functions as an external electrode having electrical conductivity and the intervention portion 10 functions as the other external electrode.

The deformation element 2 has electrical contact points X and Y. When disposing a plurality of the deformation units 3 in the outer frame body 5, the deformation units are disposed in such a manner that the electrical contact points X face the outer frame body 5 side and disposed in such a manner that the electrical contact points Y face the intervention portion 10 side.

In FIG. 14A, since the outer frame body 5 and the intervention portion 10 function as external electrodes having electrical conductivity, these deformation units 3 are disposed electrically in parallel. Therefore, a voltage applied from the power supply controller is applied equally to each deformation unit 3. Therefore, when the voltage of the deformation unit 3 is controlled, the controllability can be increased. Mentioned as a deformation element in which the voltage control is suitable are a piezoelectric element, a polymer actuator, and the like, for example.

In FIG. 14B, it is designed in such a manner that the deformation units 3 are connected to each other in series, in which both ends of the series connection are connected to the power supply controller 8.

When the deformation units 3 are disposed in series, a current applied from the power supply controller is applied equally to each deformation unit 3. Therefore, when controlling the current of the deformation unit 3, the controllability can be increased. Mentioned as a deformation element in which the current control is suitable are a shape memory alloy, a bimetal, a thermal drive actuator, and the like.

By employing the electrical connection in this embodiment, simple collection can be achieved without complicating wiring lines or the like and a simple control method can be achieved in the electrical control of the deformation units 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-173941, filed Aug. 9, 2011, which is hereby incorporated by reference herein in its entirety.

1. An actuator, comprising:
a cylindrical outer frame body which expands in a side surface direction to bring a bottom portion and a top portion close to each other; and
a deformation unit which is accommodated in the outer frame body and has a plurality of deformation elements which are deformed by applying a voltage,
in the deformation unit, the plurality of deformation elements being mutually deformed when a voltage is applied to press and expand the outer frame body in the side surface direction.

2. The actuator according to claim 1, wherein, in an area where the outer frame body and the deformation unit contact, an area contacting the side surface of the outer frame body is larger than an area of the bottom portion or the top portion.

3. The actuator according to claim 1, wherein the outer frame body has a woven fiber material on the side surface.

4. The actuator according to claim 1, wherein the deformation element is an element which bends and deforms by applying a voltage.

5. The actuator according to claim 1, further comprising a power supply which supplies a voltage to the deformation element, wherein the deformation element is an ion migration type polymer actuator.

6. The actuator according to claim 1, wherein a plurality of the deformation units are disposed in such a manner as to be laminated from the bottom portion to the top portion of the outer frame body.
